(19) United States
(12) Patent Application Publication
(10) Pub. No.: US 2013/0138845 A1
(43) Pub. Date: May 30, 2013

(54) INTEGRATED CIRCUIT NETWORK NODE CONFIGURATION

(71) Applicant: Melexis Technologies N.V., Tessenderlo (BE)

(72) Inventor: Adrian HILL, Walled Lake, MI (US)

(73) Assignee: MELEXIS TECHNOLOGIES N.V., Tessenderlo (BE)

(21) Appl. No.: 13/685,014

(22) Filed: Nov. 26, 2012

(30) Foreign Application Priority Data
Nov. 24, 2011 (GB) 1120337.9

(51) Int. Cl. G06F 13/38

(52) U.S. Cl. CPC G06F 13/385
USPC 710/104

(57) ABSTRACT

An electronic device for transmitting and/or receiving data through an electronic networking bus-system having a network topology includes an analog input connector for receiving an analog input signal representative for a network location in a network topology, and a processing unit for handling network data traffic transmitted through an electronic networking bus-system having said network topology, wherein the processing unit is further adapted for determining at least one network configuration parameter for the handling of network data traffic taking into account said input signal or digitized version thereof.

### FIELD OF THE INVENTION

The invention relates to the field of electronic devices for electronic networking bus-systems. More specifically it relates to a method and device for configuring a networking protocol in an electronic device.

### BACKGROUND OF THE INVENTION

Many network bus-system applications, such as Local Interconnect Network (LIN), Inter-Integrated Circuit bus (I²C), Serial Peripheral Interface bus (SPI) or parallel I/O bus applications, use a plurality of similar modules on the same bus line, while each module needs to be addressed individually. For example, such an application may be a low-end, e.g. cheap and easy to implement, sensor network in automotive applications, e.g. a network connecting multiple sensors and/or actuators to a master node in a vehicle. It is common to require addressing of such similar nodes based on the location of such nodes, e.g. the physical location or a logical location as defined by a network topology. For example, the location may define the type and/or physical monitoring position of a sensor in a sensor network, while the integrated circuits handling the bus-system network communication for each individual sensor may only differ in an arbitrary serial identification number, e.g. by inserting such integrated circuits in a random order during assembly.

Several methods for addressing nodes based on their location in a network topology are known in the art. For example, an address may be determined externally by the position the node occupies in a network topology through a plurality of external connectors of the integrated circuit node. For example pins may be used to configure a network address, e.g. by hard wiring a binary representation of an address or part of an address to a plurality of pins. An address may for example be configurable by connecting a DIP switch package or a jumper block to such external connectors of the integrated circuit. However, the additional plurality of connectors may be disadvantageous, e.g. may complicate the design of the integrated circuit chip design and the printed circuit board for receiving the chip.

Alternatively, once the integrated circuit is in place in the network, or the position that an integrated circuit will occupy in the network is determined, an address may be programmed therein, e.g. the node may store the correct address in a flash memory. However, this requires additional process steps and/or more complex process management.

The United States patent application US 2010185784 discloses a method for auto-addressing through an additional daisy chain signal line, also known as extra wire daisy chain (XWDC), in which a plurality of devices are daisy-chained, i.e. the output of a preceding device is connected to an input of a next device to form a chain. The preceding device transfers its address to the next device, and the latter determines its own address by applying an offset to the received address.

### SUMMARY OF THE INVENTION

It is an object of embodiments of the present invention to provide efficient network protocol configuration in an electronic device, e.g. a semiconductor integrated circuit device.

It is an advantage of embodiments of the present invention that robust configuration of a network protocol, e.g. assignment of a network address, may be provided, for example such configuration may be provided with limited sensitivity to broken wires, e.g. such as in a daisy chain arrangement.

It is an advantage of embodiments of the present invention that simple and cost-efficient means for configuration of a network protocol, e.g. assignment of a network address, may be provided. It is a further advantage that such configuration may be provided without programming, e.g. storing parameters to flash memory, of network nodes. It is a further advantage that such configuration may require few signal input connections, e.g. does not require a large number of connection pins, jumpers and/or DIP switches. It is a further advantage that such configuration may require no protocol extensions.

It is an advantage of embodiments of the present invention that a configuration parameter of a network protocol of a network node, e.g. a network address, may be determined by the physical location of said node, e.g. the connector to which this node is connected in a wiring harness or on a printed circuit board.

It is an advantage of embodiments of the present invention that automatic configuration of a network protocol may be provided.

The above objective is accomplished by a method and device according to the present invention.

The present invention relates to an electronic device for transmitting and/or receiving data through an electronic networking bus-system having a network topology, the device comprising an analog input connector for receiving an analog input signal representative for a network location in a network topology, and a processing unit for handling network data traffic transmitted through an electronic networking bus-system having said network topology, wherein said processing unit is further adapted for determining at least one network configuration parameter for said handling of network data traffic taking into account said input signal or a digitized version thereof.

The device furthermore may comprise an analog to digital converter unit operably connected to said analog input connector for digitizing said analog input signal in order to provide a digitized signal to the processing unit.

The analog input connector for receiving an analog input signal may be adapted for receiving an analog input signal modulated by a resistive element being representative for a network location in the network topology.

The at least one network configuration parameter may comprise a network address for identifying network data traffic directed at and/or originating from said device.

The processing unit may be adapted for implementing a slave node role in accordance to a network protocol for handling said network data traffic transmitted through said electronic networking bus-system.

The device may be a semiconductor integrated circuit device.

The present invention also relates to an electronic networking bus-system for interconnecting a plurality of electronic devices in a network topology, the system comprising a plurality of connection nodes, each connection node being configured for operably connecting an electronic device to said electronic networking bus-system, and a plurality of resistive elements arranged for providing an input signal to an analog input of the electronic device, when operably connected to one of the plurality of connection nodes, said input signal being representative for a network location of the connection node in said network topology and the electronic device being configured for determining at least one network configuration parameter for said handling of network data traffic taking into account said input signal.

The electronic networking bus-system may comprise a wiring harness comprising the plurality of connection nodes, wherein the plurality of resistive elements are positioned in the wiring harness.

The wiring harness may be implemented in an automotive environment, the electronic networking bus-system being arranged for controlling automotive electronic devices. Each respective resistive element may comprises an input terminal electrically connectable or connected to a reference voltage supply line and an output terminal electrically connected to a respective connection node to supply the analog input to the electronic device when operably connected to said connection node. The system furthermore may comprise a master network device for controlling the network data traffic transmitted through the electronic networking bus-system, said master network device being adapted for sending a configuration command to at least one electronic device when operably connected to at least one of said plurality of connection nodes in order to initiate said determining of at least one network configuration parameter.

The master network device for controlling the network data traffic may be configured for sending the configuration command at predetermined time intervals or on user-determined timing. It is an advantage of embodiments according to the present invention that the system can easily handle replacement of components and/or non-operation of components.

The master network device may be furthermore adapted for taking into account and/or confirming an initialization condition for sending said configuration command.

The master network device may be furthermore adapted for confirming a predetermined initialization condition for sending said configuration command.

The initialization condition may comprise an ambient temperature condition and/or a reference voltage level.

The electronic networking bus-system may be a broadcast serial networking bus-system.

The electronic networking bus-system may be a Local Interconnect Network.

The system may comprise an electronic device as described above.

The present invention also relates to a configuration method for configuring a node in a electronic networking bus-system having a network topology, the configuration method comprising providing to said node an analog input signal representative for a network location of said node in said network topology, and determining at least one network configuration parameter for the handling by said node of network data traffic transmitted through the electronic networking bus-system taking into account said digitized signal.

The method furthermore may comprise providing a digitized signal by digitizing the analog input signal.

Determining at least one network configuration parameter may comprise determining a network address for identifying network data traffic directed at and/or originating from said node.

Determining at least one network configuration parameter may comprise confirming a predetermined initialization condition.

Determining at least one network configuration parameter may comprise determining a set of initialization conditions and, if different from a predetermined initialization condition, calibrating for the determined initialization conditions.

Confirming a predetermined initialization condition or determining a set of initialization conditions may comprise evaluating an ambient temperature condition and/or a reference voltage level.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 shows a device according to an embodiment of the first aspect of the present invention.

FIG. 2 shows a bus-system according to an embodiment of the second aspect of the present invention.

FIG. 3 shows an illustrative method according to an embodiment of the third aspect of the present invention.

The drawings are only schematic and are non-limiting. In the drawings, the size of some of the elements may be exaggerated and not drawn on scale for illustrative purposes.

Any reference signs in the claims shall not be construed as limiting the scope. In the different drawings, the same reference signs refer to the same or analogous elements.

### DETAILED DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

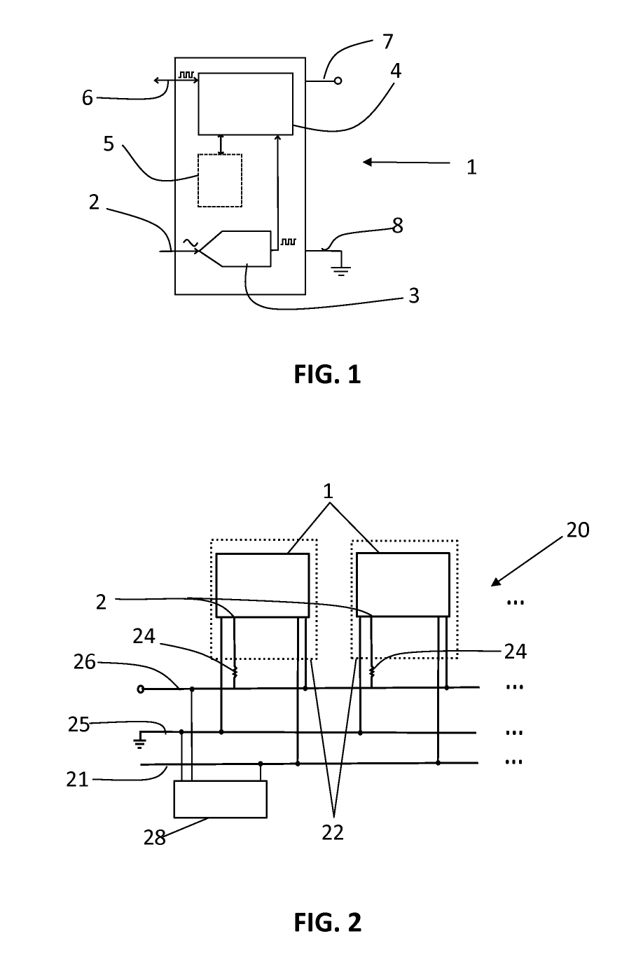

In a first aspect, the present invention relates to an electronic device, e.g. a semiconductor integrated circuit device, for transmitting and/or receiving data through an electronic networking bus-system having a network topology. For example, such an electronic device, e.g. a semiconductor integrated circuit device, may transmit sensor data over the electronic networking bus-system, and/or may receive data from the bus-system for controlling actuators, embodiments of the present invention not being limited thereto. According to embodiments of the present invention, the device comprises an analog input connector for receiving an analog input signal representative for a network location in a network topology and a processing unit for handling network data traffic transmitted through an electronic networking bus-system having said network topology, wherein the processing unit is further adapted for determining at least one network configuration parameter for said handling of network data traffic taking into account said input signal. Standard and optional features are described below in more detail, with reference to FIG. 1.

Embodiments according to this first aspect of the invention may be particularly suited for bus-systems having a single master and a small number of slave nodes, e.g. less than 65, or less than 33, or less than 17, for example up to 12 nodes. For example, the bus-system may be an I²C bus, an SPI bus or a parallel I/O bus. The bus-system may be a low-cost and easy to implement networking bus-system, such as a serial communication bus-system, e.g. a broadcast serial bus-system, for example a Local Interconnect Network. The network topology may thus be defined by master connected to a number of individually addressable slave node positions on a serial line. A plurality of similar devices according to embodiments of the invention may be connected to one bus-system, such that, although the individual devices may be removable, replaceable and/or interchangeable, each location of such a device in the network topology, e.g. individually addressable slave node position, may be uniquely identified, e.g. to differentiate the behaviour of the individual devices as function of the location in the network topology.

FIG. 1 schematically depicts an embodiment of such an electronic device, e.g. a semiconductor integrated circuit device, 1. This device 1 may typically be an integrated circuit electronic chip, e.g. a silicon chip in an encapsulation package. Such an encapsulation package may typically provide a number of connectors, i.e. signal conduction contacts, e.g. conductive pins or pads for connecting the integrated circuit to signal wires or to a printed circuit board, for example using a surface mount technique or a through-hole technique. Typically, at least one of such connectors may provide a power supply 7, e.g. a substantially constant voltage level relative to a common ground, and at least one of such connectors may provide a ground 8 connection. Whereas typically the electronic device may be one integrated circuit on which the different components are integrated, alternatively one or more standard or optional components of the electronic device may be present as an electronic component external to the integrated circuit.

The device 1 comprises an analog input connector 2, e.g. a connector pin or contact pad of a chip encapsulation package, for receiving an analog input signal, e.g. a signal represented by a voltage level or a current supplied to the analog input connector 2. This analog input signal is representative for a network location in a network topology. For example, the device 1 may be, in operation, connected to an electronic networking bus-system, for example a broadcast serial networking bus-system, e.g. a single master to multiple slaves broadcast communication protocol implemented on a serial digital communication line. The analog input signal determines the location of the device 1 in the network topology, e.g. in order to differentiate the device from other such devices connected to the same electronic networking bus-system. Particularly, the device 1 may be suitable for connecting to an electronic networking bus-system 20 according to the second aspect of the present invention described further hereinbelow.

The device 1 further may comprise an analog to digital converter unit 3, which is operably connected to the analog input connector 2 for digitizing said input signal in order to provide a digitized signal. In some embodiments the analog to digital converter 3 can be omitted and the chip may operate as a pure analog chip. This analog to digital converter unit 3 may be adapted for converting the analog input signal, e.g. voltage level or current, to a quantized representation, e.g. a binary representation, for example a digital number proportional to the analog input signal, e.g. proportional to the magnitude of the voltage or current presented at the analog input connector 2. The analog to digital converter unit 3 may convert the analog input signal to signals on a plurality of digital signal lines, e.g. to form a parallel bitwise representation of the analog input signal, or may convert the analog input signal to a signal on a single digital signal line, e.g. to form a serial, discrete-time digital representation of the analog input signal. The digitized signal may be a base two numerical representation, or a representation in a different digital numerical encoding scheme, e.g. a Gray code or a BCD code. In particular embodiments, the analog to digital converter unit 3 may receive the analog input signal directly, e.g. through a direct conductive path, from the analog input connector 2, while in other embodiments, the analog to digital converter unit 3 may receive the analog input signal indirectly, e.g. through a multiplexing arrangement adapted for providing a selected signal from a plurality of analog input signals to the analog to digital converter unit 3. For example, the device 1 may be adapted for obtaining sensor data from analog sensor signal lines and transmitting such sensor data in a digital representation over the bus-system. Furthermore, the analog to digital converter unit 3 may be adapted for performing digital to analog conversion, e.g. to drive actuators connected to analog output signal lines in response to data received over the bus-system. In advantageous embodiments, an existing design for an electronic device having bus-system communication features and analog to digital conversion capabilities, e.g. for sensor readout, may be easily adapted, e.g. programmed, to provide a device 1 according to embodiments of this first aspect of the invention. Whereas it was indicated that typically the electronic device is an integrated circuit and the analog to digital converter than will be part of it, alternatively the analog to digital converter may be an external analog to digital converter element part of the electronic device and may transfer the digitized information to an integrated circuit component.

The device 1 further comprises a processing unit 4 for handling network data traffic transmitted through an electronic networking bus-system having said network topology. For example, the device 1 may have a connector 6 for interfacing with such an electronic networking bus-system, e.g. one or more connection pads or pins for sending and/or receiving signals from such bus-system. The processing unit 4 may implement a network protocol for interacting with the electronic networking bus-system, for example a standardized communication protocol, e.g. a Local Interconnect Network specification. Particularly, in embodiments according to the first aspect of the present invention, the processing unit 4 may be adapted for implementing a slave node role in accordance to a network protocol for handling the network data traffic transmitted through the electronic networking bus-system.

Such network data traffic on a bus-system interconnecting a plurality of network nodes, e.g. having more than two devices connected to the bus-system, may typically comprise identifiers for source and/or destination nodes connected to the network, e.g. network addresses. In embodiments according to the first aspect of the present invention, the processing unit 4 is adapted for, e.g. programmed for, determining at least one network configuration parameter for the handling of network data traffic taking into account the obtained input signal, e.g. in digitized form provided by the analog to digital converter unit 3 or in analog form. Particularly, this at least one network configuration parameter may comprise a network address for identifying network data directed at and/or originating from the device 1.

For example, the device 1 may furthermore comprise a memory management unit 5, e.g. for interfacing a read-only memory, a random access memory and/or a flash memory to the processing unit 4. When initializing network communications, the processing unit 4 may store the input signal or a digitized form thereof in a random access memory and use this value as a network address, or part of a network address, e.g. in combination with a complementary part stored in a read-only memory, when transmitting and/or receiving data through the electronic networking bus-system. Alternatively, the input signal or a digitized form thereof may be used as an indexing pointer in a look-up table, e.g. a table of network addresses stored in a flash memory or a read-only memory. This initializing of network communications may for example occur during a preprogrammed startup sequence when executed after receiving a power supply, when receiving a reset signal on a reset signal connector, or when receiving a specific datapackage, e.g. a broadcast message sent by a master node, on the electronic networking bus-system. For example, a network address initialization may be executed when receiving a ‘select config’ command in accordance to a Local Interconnect Network protocol specification, e.g. a LIN 2.x specification. The processing unit 4 may be adapted for implementing a slave node role in accordance to a network protocol, e.g. a LIN specification, for handling network data traffic transmitted through the electronic networking bus-system.

In particular embodiments, the device 1 may furthermore be adapted for confirming a predetermined initialization condition when determining the at least one network configuration parameter. The system therefore may comprise an initialization condition determining means adapted for checking a set of initialization conditions. It is an advantage of at least some embodiments of the present invention that for accuracy reasons, environmental conditions may be taken into account. The initialization condition determining means may comprise one or more sensors for sensing the environmental conditions. In some embodiments, the initialization condition determining means may determine whether or not the at least one network configuration parameter can be determined. Alternatively, the initialization condition determining means may be in communication with a processor allowing to correct the determination of the at least one network configuration parameter as function of the initialization condition or the difference between the sensed condition and the standard conditions at which the system is calibrated. The latter may e.g. be based on an algorithm, a look up table or a neural network.

For example, the validity of the input signal representative for the network location of the device 1 may be checked by comparing a sensor input, e.g. an ambient temperature measurement and/or by comparing a reference voltage input, e.g. of a voltage supply line of the device 1, to a predetermined validity range. The electronic networking bus-system 20 may be a broadcast serial networking bus-system, e.g. a Local Interconnect Network.

In a second aspect, the present invention relates to an electronic networking bus-system 20 for interconnecting a plurality of electronic devices in a network topology, for example a plurality of devices 1 according to the first aspect of the present invention.

FIG. 2 shows an embodiment of such bus-system 20 according to this second aspect of the invention. This system 20 comprises a plurality of connection nodes 22, in which each connection node is adapted for operably connecting an electronic device, e.g. semiconductor integrated circuit device, 1 to the electronic networking bus-system 20. Such connection nodes may comprise connectors for interfacing the electronic device 1 with the bus-system, e.g. may comprise leads for connecting the device to at least one communication signal line 21, with a power supply, e.g. may comprise leads for connecting to a reference voltage supply line 26 and a ground 25, and with other peripheral components, e.g. sensors and/or actuators. Such an electronic device 1 comprises an analog input connector 2 for receiving the analog input signal, optionally an analog to digital converter unit 3 for digitizing the analog input signal in order to provide a digitized signal, and a processing unit 4 for handling network data traffic transmitted through the electronic networking bus-system 20. The processing unit 4 is further adapted for determining at least one network configuration parameter for this handling of network data traffic taking into account the input signal, optionally being digitized. Particularly, the device 1 may be a device according to embodiments of the first aspect of the present invention.

The system 20 further comprises a plurality of resistive elements 24 for providing an input signal to an analog input of the electronic device 1 when operably connected to one of the plurality of connection nodes 22, in which the input signal is representative for a network location of this connection node 22 in the network topology. Each respective resistive element 24 may comprise an input terminal electrically connected to a reference voltage supply line 26 and an output terminal electrically connected to a respective connection node 22 to supply the analog input 2 of an electronic device 1 when operably connected to this connection node 22. For example, a reference voltage supply line 26 may power a device 1 connected to a connection node 22, e.g. supply a voltage of 12V relative to a common ground, while a resistive element 24 may supply a lower voltage indicative of the position of the connection node 22 in the network topology, e.g. by forming part of a resistive bridge in combination with a resistance on a connection path to ground, e.g. an internal resistance in the device 1, for example part of the analog to digital converter unit. Alternatively, a resistive element 24 may be arranged to provide a pathway to ground of predetermined resistance in parallel to the analog input of the device 1.

The electronic networking bus-system 20 may furthermore comprise a master network device 28 for controlling the network data traffic transmitted through the electronic networking bus-system 20. This master network device 28 may be adapted for sending a configuration command, e.g. via a communication signal line 21, to at least one electronic device 1 when operably connected to at least one of said plurality of connection nodes 22 in order to initiate said determining of at least one network configuration parameter. For example, this command may be a ‘select config’ command according to a LIN specification. The master network device 28 may be adapted for confirming a predetermined initialization condition for sending said configuration command. This predetermined initialization condition may comprise an ambient temperature condition, e.g. a room temperature condition, e.g. within a range of 24° C. to 26° C., or e.g. within 15° C. to 30° C. This predetermined initialization condition may comprise a reference voltage level, e.g. a voltage sufficiently close to 12V, for example in order to ensure in a battery powered system a sufficient battery charge.

In particular embodiments a single analog input 2 may suffice to encode a network parameter, e.g. an address, associated with a particular location, e.g. the connection node 22. This encoded parameter may be provided by cheap and efficient means, e.g. a resistor or multiple resistors to provide a voltage or current conditioned to a predetermined level, for example a constant current or voltage of predetermined magnitude. In some of these embodiments, an analog to digital converter unit of the devices 1 may be adapted to provide a linear quantization of the received voltage or current, e.g. in a number of bins from a minimum, e.g. ground voltage, to a maximum, e.g. a power supply voltage, e.g. 3V, 6V or 12V. The resistive elements in the bus-system may hence be adapted to provide the voltage or current magnitudes corresponding to the respective central values of the bins at the connection nodes.

In other embodiments multiple analog inputs 2 may be used to encode a network parameter or multiple network parameters, e.g. an address. For example, a grid configuration may be provided in which a first analog input receives an analog input signal representative of a latitudinal coordinate relative to this grid, while a second analog input receives an analog input signal representative of a longitudinal coordinate relative to this grid. Other configurations may be envisioned, for example, a bus-system may have a hierarchical network topology, and a location in the hierarchy at different levels may thus be indicated by different analog inputs.

While the resistive elements 24 may reside on a central bock, e.g. close to a master device 28, and have individual conductive connections to the connection nodes 22, it may be advantageous to provide these resistive elements in close proximity to the connection nodes 22. For example, these resistive elements 24 may be integrated in a wiring harness. Alternatively in one embodiment, these resistive elements may for example be provided on a printed circuit board (PCB) for receiving the device 1. Multiple resistive elements 24 may be combined to provide a suitable conditioned analog input for a device 1, and these resistive elements 24 may be physically located in different components of the bus-system. For example a resistive element 24 of the wiring harness may be combined with a resistive element on a PCB for receiving a device 1, e.g. to form a resistive bridge. In other embodiments, an array of resistive elements may be provided on the PCB, and, depending on the connection node 22 in which this PCB will reside in the bus-system 20, one or a selected combination of the resistive elements may be connected to the analog input 2, e.g. by soldering.

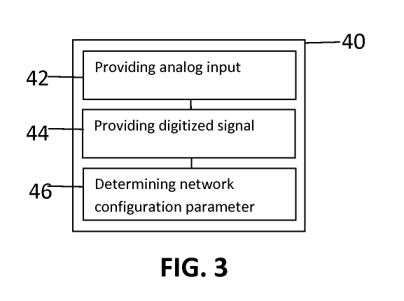

In a third aspect, the present invention relates to a configuration method 40 for configuring a node in a electronic networking bus-system having a network topology, e.g. a device 1 according to embodiments of the first aspect of the present invention in a bus-system according to embodiments of the second aspect of the present invention. An exemplary method 40 according to this third aspect is illustrated in FIG. 3.

The configuration method 40 comprises the step of providing 42 to the node an analog input signal representative for a network location of the node in the network topology. The configuration method 40 optionally comprises the step of providing 44 a digitized signal, in which this providing of a digitized signal comprises digitizing the analog input signal in the node. The configuration method 40 also comprises the step of determining 46 at least one network configuration parameter for the handling by the node of network data traffic transmitted through the electronic networking bus-system taking into account the input signal, optionally being digitized first. The determining 46 of at least one network configuration parameter may comprise determining a network address for identifying network data traffic directed at and/or originating from the node. The determining 46 at least one network configuration parameter may comprise confirming a predetermined initialization condition, e.g. evaluating an ambient temperature condition and/or a reference voltage level.

1. An electronic networking bus-system for interconnecting a plurality of electronic devices in a network topology, the system comprising:
a plurality of connection nodes, each connection node being configured to operably connect an electronic device to said electronic networking bus-system, and
a plurality of resistive elements arranged to provide an input signal to an analog input of the electronic device, when operably connected to one of the plurality of connection nodes, said input signal being representative for a network location of the connection node in said network topology and the electronic device being configured to determine at least one network configuration parameter handling network data traffic taking into account said input signal.

2. The electronic networking bus-system according to claim 1, the electronic networking bus-system comprising a wiring harness comprising the plurality of connection nodes, wherein said plurality of resistive elements are positioned in said wiring harness.

3. The electronic networking bus-system according to claim 2, wherein the wiring harness is implemented in an automotive environment, said electronic networking bus-system being arranged to control automotive electronic devices.

4. The electronic networking bus-system according to claim 1, wherein each respective resistive element comprises an input terminal electrically connectable or connected to a reference voltage supply line and an output terminal electrically connected to a respective connection node to supply the analog input to the electronic device when operably connected to said connection node.

5. The electronic networking bus-system according to claim 1, comprising a master network device control the network data traffic transmitted through the electronic networking bus-system, said master network device being configured to send a configuration command to at least one electronic device when operably connected to at least one of said plurality of connection nodes to initiate said determining of at least one network configuration parameter.

6. The electronic networking bus-system according to claim 5, wherein the master network device controlling the network data traffic is configured send the configuration command at predetermined time intervals or on user-determined timing.

7. The electronic networking bus-system according to claim 5, wherein said master network device is furthermore configured to take into account and/or confirm an initialization condition to enable sending said configuration command.

8. The electronic networking bus-system according to claim 7, wherein said initialization condition comprises an ambient temperature condition and/or a reference voltage level.

9. The electronic networking bus-system according to claim 1, wherein said electronic networking bus-system is a broadcast serial networking bus-system.

10. The electronic networking bus-system according to claim 1, wherein said electronic networking bus-system is a Local Interconnect Network.

11. An electronic device for transmitting and/or receiving data through an electronic networking bus-system having a network topology, the device comprising:
an analog input connector arranged to receive an analog input signal representative for a network location in a network topology, and
a processing unit arranged to handle network data traffic transmitted through an electronic networking bus-system having said network topology,
wherein said processing unit is further configured to determine at least one network configuration parameter for said handling of network data traffic taking into account said input signal or a digitized version thereof.

12. The device according to claim 11, comprising an analog to digital converter unit operably connected to said analog input connector to digitize said analog input signal to provide a digitized signal to the processing unit.

13. The device according to claim 11, wherein the analog input connector is arranged to receive an analog input signal modulated by a resistive element that is representative for a network location in the network topology.

14. The device according to claim 11, wherein said at least one network configuration parameter comprises a network address that identifies network data traffic directed at and/or originating from said device.

15. The device according to claim 11, wherein said processing unit is arranged to implement a slave node role in accordance with a network protocol for handling said network data traffic transmitted through said electronic networking bus-system.

16. The device according to claim 11, comprising a semiconductor integrated circuit device.

17. A configuration method for configuring a node in a electronic networking bus-system having a network topology, the steps comprising:
providing to said node an analog input signal representative for a network location of said node in said network topology, and
determining at least one network configuration parameter for the handling by said node of network data traffic transmitted through the electronic networking bus-system taking into account said digitized signal.

18. The method according to claim 17, comprising providing a digitized signal by digitizing the analog input signal.

19. The method according to claim 17, wherein said determining at least one network configuration parameter comprises determining a network address enabling identifying network data traffic directed at and/or originating from said node and/or comprises confirming a predetermined initialization condition and/or comprises determining a set of initialization conditions and, if different from a predetermined initialization condition, calibrating for the determined initialization conditions.

20. The method according to claim 19, wherein said confirming a predetermined initialization condition or determining a set of initialization conditions comprises evaluating an ambient temperature condition and/or a reference voltage level.
